(19) United States
(12) Patent Application Publication
(10) Pub. No.: US 2009/0161925 A1
(43) Pub. Date: Jun. 25, 2009

(54) Method for acquiring the shape of the iris of an eye

(75) Inventors: Martin Cottard, Vaucresson (FR); Gilles Monteilliet, Us (FR)

Correspondence Address: BRIGGS AND MORGAN P.A., 2200 IDS CENTER, 80 SOUTH 8TH ST, MINNEAPOLIS, MN, 55402, US

(73) Assignee: Sagem Securite, Paris (FR)

(21) Appl. No.: 11/919,087

(22) PCT Filed: Apr. 25, 2006
(86) PCT No.: PCT/FR2006/000935

§ 371 Date: Dec. 22, 2008

(30) Foreign Application Priority Data
Apr. 25, 2005 (FR) 0504132

(51) Int. Cl. G06K 9/00; G06T 15/50

(52) U.S. Cl. 382/128; 345/426

(57) ABSTRACT

The invention concerns a method of acquiring the shape of the iris of an eye, comprising:
a step of capture (112), by at least one image sensor, of at least one image of the iris, each image corresponding to the illumination of the iris by a light beam;
a step of constructing (114) the three-dimensional shape of the iris from the image or images thus captured; and
a step of verifying the non-flatness of the three-dimensional shape of the iris thus constructed.

The present invention concerns a method of acquiring the shape of the iris of an eye. The invention also concerns a method of recording the shape thus acquired and a method of identifying the shape thus acquired, as well as an acquisition device adapted to implement one of these methods. It finds an application in the field of biometric recognition and in particular in the field of identification by recognition of the iris of the eyes.

Recognition of the iris of an eye is used to protect installations such as for example buildings or machines. This technology makes it possible to dispense with access codes or cards, which may be stolen or falsified. The use of this technology makes it possible to reinforce security since the probability that two persons have two identical irises is almost zero.

Iris recognition is based on the comparison of the image of the iris of the user with a reference set of iris images stored in a database or on the comparison of a code relating to the iris with a set of codes stored in a database. The codes are generated by an algorithm from the image of the iris and contain a set of information characteristic of the image of the iris. As with the images of irises, these codes are unique for each individual. These codes can be considered to be models representing the corresponding irises and are conventionally referred to as “biometric iris templates”.

In the case of the use of an iris recognition device, each person must first of all record the image or template of his iris in a database during a recording stage. When one of the persons wishes to be recognised subsequently, he must have the image or template of his iris recognised during an identification stage, by comparison with all the images or templates recorded.

The recording stage and the identification stage have recourse to a method of acquiring the image of the iris during which an image of the iris is captured. This image, which corresponds to a photograph of the iris, is either directly stored in the database or coded in the shape of a template that is then stored in the database. In either case, the stored element corresponds to a projection of the iris onto a plane and the processing operations that can be performed on these representations of the iris are limited by the flatness of these projections. This is because the processing operations such as for example the generation of templates or the comparison of templates or of images are limited to the use of these projections and do not use the three-dimensional shape of the eye.

One object of the present invention is to propose a method of acquiring the iris of an eye that does not have the drawbacks of the prior art and that, in particular, dispenses with the limitation to a processing of the flat projections of the iris.

For this purpose, a method of acquiring the shape of the iris of an eye is proposed, comprising:
a step of capture, by at least one image sensor, of at least one image of the iris, each image corresponding to the illumination of the iris by a light beam;
a step of constructing the three-dimensional shape of the iris from the image or images thus captured; and
a step of verifying the non-flatness of the three-dimensional shape of the iris thus constructed.

According to a particular embodiment, the construction step comprises the following steps:
analysis, on the image or images captured, of the shades of light intensities generated by each light beam on the iris; and
generation of the three-dimensional shape from the said analysis of the shades of light intensities.

According to another particular embodiment, the direction of illumination of at least one of the light beams forms a non-zero angle with the optical axis of at least one of the image sensors, and the construction step comprises the following steps:
analysis, on the image or images captured, of the shadows generated by each light beam on the iris; and
generation of the three-dimensional shape from the said analysis of the shadows.

According to another particular embodiment, the illumination of the iris consists of a projection of a test pattern onto the iris, and the construction step comprises the following steps:
analysis, on the image or images captured, of the deformations of the test pattern thus projected;
generation of the three-dimensional shape from the said analysis of the deformations.

The invention also proposes a method of recording the three-dimensional shape of the iris of an eye in the database of three-dimensional reference iris shapes, comprising the following steps:

three-dimensional acquisition of the shape of the iris by an acquisition method according to one of the above variants; and

recording of the three-dimensional shape of the iris in the database.

The invention also proposes a method of identifying the three-dimensional shape of the iris of an eye from a database of three-dimensional reference iris shapes, comprising the following steps:
three-dimensional acquisition of the shape of the iris by an acquisition method according to one of the preceding variants;
verification of the non-flatness of the said three-dimensional shape of the iris acquired; and
comparison of the said three-dimensional shape thus acquired with the three-dimensional reference iris shapes in the database.

The invention also proposes a device for acquiring the three-dimensional shape of the iris of an eye, adapted to implement one of the above acquisition methods, comprising:
illumination means adapted to emit one or more light beams onto the iris;
at least one image sensor;
means of constructing the three-dimensional shape of the iris from at least one image of the iris captured by each image sensor.

The invention also proposes a device for acquiring the three-dimensional shape of the iris of an eye, adapted to implement the above recording method, comprising:
illumination means adapted to emit one or more light beams onto the iris;
at least one image sensor;
means of constructing the three-dimensional shape of the iris from at least one image of the iris captured by each image sensor;
a database of three-dimensional reference iris shapes; and
means of recording the said three-dimensional shape in the said database of three-dimensional reference iris shapes.

The invention also proposes a device for acquiring the three-dimensional shape of the iris of an eye, adapted to implement the above identification method, comprising:
illumination means adapted to emit one or more light beams onto the iris;
at least one image sensor;
means of constructing the three-dimensional shape of the iris from at least one image of the iris captured by each image sensor;
means of verifying the non-flatness of the three-dimensional shape of the iris;
a database of three-dimensional reference iris shapes; and
means of comparing the three-dimensional shape of the iris to be identified with the three-dimensional reference iris shapes.

The characteristics of the invention mentioned above, as well as others, will emerge more clearly from a reading of the following description of an example embodiment, the said description being given in relation to the accompanying drawings, among which:

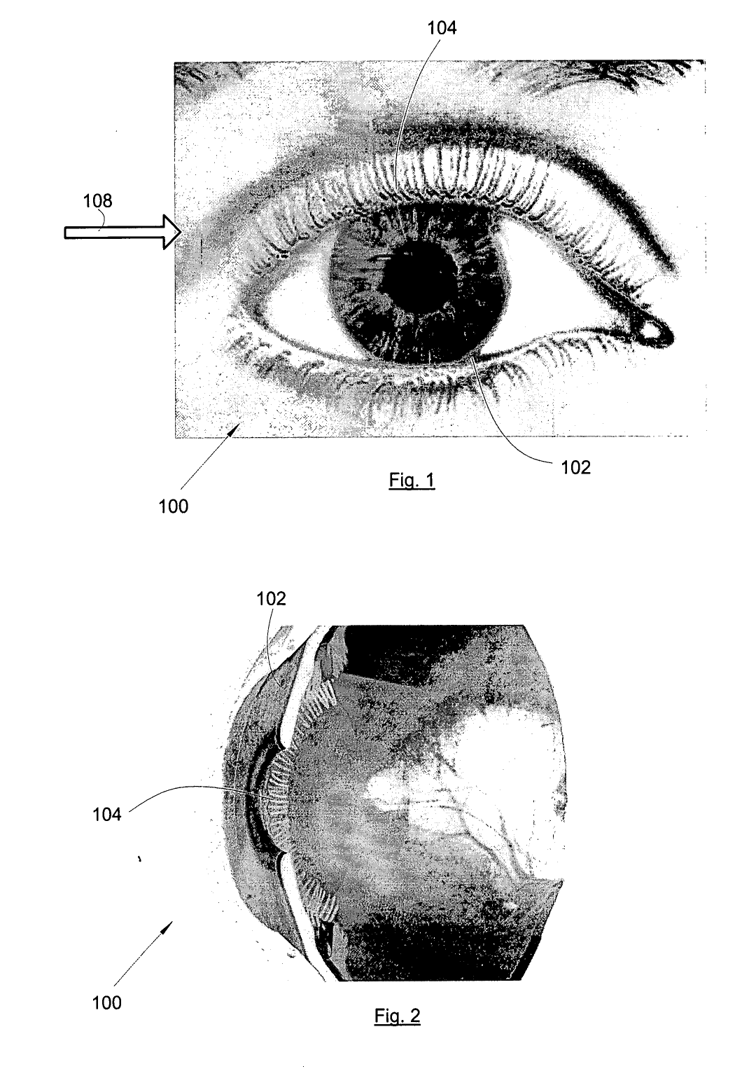

FIG. 1 is the schematic representation of an eye seen in front view;

FIG. 2 is the schematic representation of an eye in cross-section;

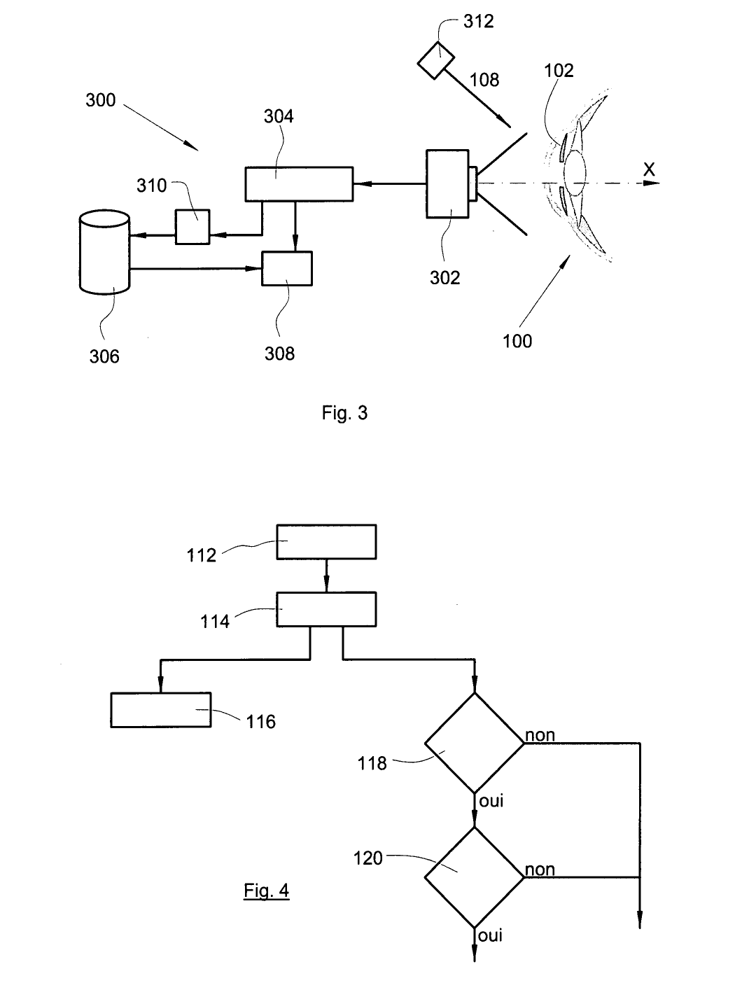

FIG. 3 depicts an acquisition device according to the invention; and

FIG. 4 depicts an algorithm of an acquisition method according to the invention.

In the context of the present invention, an object, in particular an iris, is said to be three-dimensional if, in a three-dimensional reference frame (O,x,y,z), the visible surface of the object is a graph described by the equation z=u(x,y), where u is not a constant function.

The visible surface of the object that is the external surface of the object as observed thus consists of a set of points P of coordinates {x,y,z=u(x,y)} each having at least one optical characteristic such that its reflectance R(Theta, Omega), which is a function of the wavelength (Omega) of the light emitted by a source S, and a function of the angle Theta according to which P “sees” the source S. A shape of the three-dimensional object is thus defined and said to be three-dimensional if it is modelled in the shape of a set of numerical values each corresponding to at least one optical characteristic attributed to points P′ representing the visible surface of the three-dimensional object and which have as their coordinates, in a three-dimensional reference frame (O′,x′,y′,z′), {x′,y′,z′=u′(x′,y′)}, where u′ is not a constant function.

FIG. 1 depicts a schematic view of an eye 100, the iris 102 of which surrounds the pupil 104.

FIG. 2 depicts a view in section of the eye 100. The iris 102 has the shape of a dome, the top of which has in it a hole corresponding to the pupil 104. Not only is the iris 104 not flat because of its overall dome shape but it also comprises, on its surface, reliefs in the shape of hollows and protrusions that are shown diagrammatically in FIG. 1 by shades of grey. The general shape of the iris and the reliefs that produce a three-dimensional shape are specific to each individual or group of individuals and, according to the present invention, an identification of each individual can be based on the similarity of the three-dimensional shape of the iris 102 to reference irises stored in the form of three-dimensional shapes. A study of this similarity makes it possible to refine the identification process since this is not limited to a study of the similarity of the templates or images representing the flat projections of the iris 102, but takes into account the actual representation of the iris 102.

FIG. 3 depicts an acquisition device 300 adapted to implement the methods that will be described subsequently, and comprising:
illumination means 312 adapted to emit one or more light beams 108 onto the iris 102 when the latter is in the acquisition position;
at least one image sensor 302, for example of the CCD type; and
means 304 of constructing a three-dimensional shape of the iris 102 from at least one image of the iris 102 captured by each image sensor 302.

The acquisition device 300 captures at least one image of the iris 102 by means of the image sensor or sensors 302. Each image corresponds to a light beam 108, that is to say each image corresponds to the illumination of the iris 102 by a light beam 108. The image or images thus captured are then transmitted to the construction means 304, which generate the three-dimensional shape of the iris 102 from these images by one of the methods that will be explained below.

During the recording phase, a database 306 of three-dimensional reference iris shapes and means 310 of recording the said three-dimensional shape in the said database 306 are used by the acquisition device 300. During the identification stage, the database 306 of three-dimensional reference iris shapes and means 308 of comparing the three-dimensional shape of the iris 102 to be identified with the three-dimensional reference iris shapes are used by the acquisition device 300.

The construction means 304, the comparison means 308 and the recording means 310 are preferably software means implemented in a conventional manner in an electronic system.

The database 306 is not necessarily located at the rest of the acquisition device 300, but may be offset.

The illumination means 312 can take the form of one or more emitters 108 of light beams, the wave fronts of which are structured so as to illuminate the iris 102 in the manner of an oblique beam.

FIG. 4 is a diagram illustrating an algorithm for implementing a method of acquiring the shape of the iris 102 of an eye 100.

The method of acquiring the shape of the iris 102 of an eye 100 comprises:
a step 112 of capture, by at least one image sensor 302, of at least one image of the iris 102, each image corresponding to the illumination of the iris 102 by a light beam 108;
a step 114 of constructing the three-dimensional shape of the iris 102 from the image or images thus captured.

When the three-dimensional shape of the iris 102 can be generated from a single view of the iris 102, the capture step 112 can be limited to the capture of an image of the iris 102 by an image sensor 302.

When the three-dimensional shape of the iris 102 is generated from several views of the iris 102, either the same image sensor 302 takes several images corresponding to different light beams 108, or there are several image sensors 302 that each capture one or more images of the iris 102, each image thus captured corresponding to a particular light beam 108.

The light beam or beams reveal the three-dimensional shape of the iris 102 and in particular the hollows and protrusions of the reliefs on the iris 102. This is because the lighting of a three-dimensional object by a light beam generates, at each point P on the illuminated surface of this object, a luminance that depends on the position of the point P with respect to the illumination means 312 and/or the shadows due to the reliefs on the illuminated surface that are projected onto the said surface.

The captured image can be a three-dimensional shape, and the construction step 114 is then limited to a direct interpretation of the capture. The capture can be effected for example by a method of the telemetry type or by analysis of the phase difference between a signal emitted in the direction of the eye 100 and its reflection.

The image or images captured may be flat images. The construction step 114 then reconstructs the three-dimensional shape of the iris 102 from this flat image or images.

These acquisition methods thus make it possible to obtain a three-dimensional shape of the iris 102 and this shape can then be used to refine the results of subsequent processing operations to which it will be subjected, thus making it possible to dispense with the limitations of the acquisition devices of the prior art.

When the light beam or beams 108 reveal the reliefs present on the iris 102 by the generation of shadows present on the captured images, the direction of illumination of at least one of the light beams 108 forms a non-zero angle with the optical axis X of at least one of the image sensors 302, and the shadows are processed during the construction step 114 in order to generate the three-dimensional shape of the iris 102. The construction step 114 then comprises a step of analysing, on the image or images captured, the shadows generated by the light beam 108 on the iris 102; and a step of generating the three-dimensional shape from the said analysis of the shadows.

Another method of reconstructing the three-dimensional shape of the iris 102 uses the shades of light intensities, in particular the shades of grey, generated by the light beams 108 on the iris 102 and visible on the captured images. The construction step 114 then comprises a step of analysing, on the image or images captured, the shades of light intensities generated by each light beam 108 on the iris 102; and a step of generating the three-dimensional shape from the said analysis of the shades of light intensities.

These methods are called, in general terms, the technique of “shape from shading” or photoclinometry and are techniques of three-dimensional reconstruction from a flat image. These methods, which have been developed for many years, will not be described in more detail and in particular the document entitled “Shape from shading: a method for obtaining the shape of a smooth opaque object from one view” by Berthold K P Horn, the document entitled “Shape of shading: a survey” by R Zhang and the DEA report of F Coutelle entitled “Taking into account the pin-diagram model for extracting relief in monovision” will be cited.

These methods, which require the capture of a single image when the colour of the target, that is to say here the iris, is uniform, preferably use a plurality of images captured in different directions of illumination because of the non-uniformity of the colour of the iris.

Another method of reconstructing the three-dimensional shape of the iris 102 consists of projecting a test pattern onto the iris 102 and analysing the deformations of the test pattern thus protected in order to deduce therefrom the shape of the iris 102.

The test pattern can for example take the form of fringes that are projected onto the iris 102. The test pattern is then projected in a deformed manner onto the surface of the iris 102 and capturing images of these deformations makes it possible to generate the three-dimensional shape of the iris 102 by geometric calculations.

The illumination of the iris 102 then consists of a projection of a test pattern onto the iris 102, and the construction step 114 comprises the following steps:
analysis, on the image or images captured, of the deformations of the test pattern thus projected;
generation of the three-dimensional shape from the said analysis of the deformations.

These methods have recourse, in general terms, to the techniques of reconstruction of the three-dimensional shape by the use of structured light. These methods, which have been developed for many years, will not be described in more detail and there will be cited in particular the thesis by Benoit Bocquillon “Computing ground truth for stereoscopic matching”, and the article by D Scharstein and R Szeliski “High-Accuracy Stereo Depth Maps Using Structured Light”, which appeared in the journal “Computer Vision and Pattern Recognition”, volume 1, pages 195-202, in June 2003.

After the construction step 114, a step of verifying the validity of the iris 102 to be identified by verification of the non-flatness of its reconstructed three-dimensional shape can be implemented. This verification step makes it possible to verify the validity of the iris 102 present because it is not flat.

The acquisition methods that have been described above can be used in an iris recording method or an iris identification method.

The method of recording the three-dimensional shape of the iris 102 of an eye 100 in the database 306 comprises a step of three-dimensional acquisition of the shape of the iris 102 by one of the acquisition methods described above; and a step 116 of recording the three-dimensional shape of the iris 102 in the database 306.

This recording method thus makes it possible to create the database 306 of three-dimensional reference iris shapes in which there are stored the three-dimensional shapes of the iris 102 that can be identified by the identification method described below.

Establishing the step of verifying the validity of the iris 102 avoids the recording of non-valid irises.

The method of identifying the three-dimensional shape of the iris 102 of an eye 100 from the database 306 of three-dimensional reference iris shapes comprises a step of three-dimensional acquisition of the shape of the iris 102 by one of the acquisition methods described above; and a step 120 of comparing the said three-dimensional shape thus acquired with the three-dimensional reference iris shapes in the database 306.

If, during the comparison step 120, the three-dimensional shape of the iris 102 to be identified corresponds to one of the three-dimensional shapes of the reference iris then the iris 102 is recognised as belonging to an authorised person.

On the other hand, if during the comparison step 102 the three-dimensional step of the iris 102 to be identified corresponds to none of the three-dimensional reference iris shapes, then the iris 102 is considered to belong to an unauthorised person and the identification is rejected.

This identification method makes it possible to compare the three-dimensional shape of the iris 102 to be identified with all the three-dimensional reference iris shapes. Comparing a three-dimensional shape with all the three-dimensional shapes makes it possible to refine the result of this comparison since it is based on the actual shape of each iris 102 rather than on its flat projection.

In addition, the manipulation of a three-dimensional shape makes it possible to easily distinguish a real eye from a photo disposed in front of the image sensor or sensors 302. This is because, if the three-dimensional shape reconstituted is included in a flat surface, that is to say if u′(x′,y′) is a constant function, then the eye 100 present in front of the image sensor or sensors 302 is a decoy and an attempt at fraud is thus discovered. If the reconstituted three-dimensional shape is not included in a flat surface, then the eye 100 present in front of the image sensor or sensors 302 is considered to be a real eye.

Because of being able to differentiate a real eye 100 from a decoy in the form of a photograph, the comparison step is advantageously preceded by the step 118 of verifying the validity of the iris 102 to be identified.

If the validity of the iris 102 is confirmed, then the process continues with the comparison step 120. On the other hand, if the validity of the iris 102 is not confirmed, then this process terminates and the identification is rejected.

As explained above, the validity of the iris 102 can be confirmed by its three-dimensional shape, and the verification step 118 can then consist of verifying the non-flatness of the three-dimensional shape of the iris 102 and in particular the presence of reliefs. This is because the flat iris images captured at different angles of incidence of the light beam 108 are similar since no shadow is created and since no shade of colours is generated. And they are substantially similar to the captured image with frontal illumination. This characteristic of the image makes it possible to differentiate a real eye 100 from a decoy. For this purpose, the acquisition device 300 comprises means of verifying the validity of the iris 102 presented. These verification means are adapted to verify that the three-dimensional shape of the iris 102 to be identified is not a flat surface.

Naturally the present invention is not limited to the examples and embodiments described and depicted but is open to many variants accessible to persons skilled in the art.

1) A method of acquiring the shape of the iris (102) of an eye (100), comprising:
a step of capture (112), by at least one image sensor (302), of at least one image of the iris (102), each image corresponding to the illumination of the iris (102) by a light beam (108);
a step of constructing (114) the three-dimensional shape of the iris (102), reproducing its shape, from the image or images thus captured; and
a step of verifying the non-flatness of the three-dimensional shape of the iris (102) thus constructed.

2) An acquisition method according to claim 1, characterised in that the construction step (114) comprises the following steps:
analysis, on the image or images captured, of the shades of light intensities generated by each light beam (108) on the iris (102); and
generation of the three-dimensional shape from the said analysis of the shades of light intensities.

3) An acquisition method according to claim 1, characterised in that the direction of illumination of at least one of the light beams (108) forms a non-zero angle with the optical axis (X) of at least one of the image sensors (302), and in that the construction step (114) comprises the following steps:
analysis, on the image or images captured, of the shadows generated by each light beam (108) on the iris (102); and
generation of the three-dimensional shape from the said analysis of the shadows.

4) An acquisition method according to claim 1, characterised in that the illumination of the iris (102) consists of a projection of a test pattern onto the iris (102), and in that the construction step (114) comprises the following steps:
analysis, on the image or images captured, of the deformations of the test pattern thus projected;
generation of the three-dimensional shape from the said analysis of the deformations.

5) A method of recording the three-dimensional shape of the iris (102) of an eye (100) in a database (306) of three-dimensional reference iris shapes, comprising the following steps:
three-dimensional acquisition of the shape of the iris (102) by an acquisition method (112, 114) according to one of claims 1 to 4; and
recording (116) of the three-dimensional shape of the iris (102) in the database (306).

6) A method of identifying the three-dimensional shape of the iris (102) of an eye (100) from a database (306) of three-dimensional reference iris shapes, comprising the following steps:
three-dimensional acquisition of the shape of the iris (102) by an acquisition method (112, 114) according to claim 1;
verification (118) of the non-flatness of the said three-dimensional shape of the iris (102) acquired; and
comparison (120) of the said three-dimensional shape thus acquired with the three-dimensional reference iris shapes in the database (306).

7) A device (300) for acquiring the three-dimensional shape of the iris (102) of an eye (100), adapted to implement a method according to of claim 1 to 4, comprising:
illumination means (312) adapted to emit one or more light beams (108) onto the iris (102);
at least one image sensor (302);
means of constructing (304) the three-dimensional shape of the iris (102) from at least one image of the iris (102) captured by each image sensor (302).

8) A device (300) for acquiring the three-dimensional shape of the iris (102) of an eye (100), adapted to implement the method of claim 5, comprising:
illumination means (312) adapted to emit one or more light beams (108) onto the iris (102);
at least one image sensor (302);
means of constructing (304) the three-dimensional shape of the iris (102) from at least one image of the iris (102) captured by each image sensor (302);
a database (306) of three-dimensional reference iris shapes; and
means of recording (310) the said three-dimensional shape in the said database (306) of three-dimensional reference iris shapes.

9) A device (300) for acquiring the three-dimensional shape of the iris (102) of an eye (100), adapted to implement a method according to claim 6, comprising:
illumination means (312) adapted to emit one or more light beams (108) onto the iris (102);
at least one image sensor (302);
means of constructing (304) the three-dimensional shape of the iris (102) from at least one image of the iris (102) captured by each image sensor (302);
means of verifying the non-flatness of the three-dimensional shape of the iris (102);
a database (306) of three-dimensional reference iris shapes; and
means of comparing (308) the three-dimensional shape of the iris (102) to be identified with the three-dimensional reference iris shapes.
